(19) United States
(12) Patent Application Publication
(10) Pub. No.: US 2022/0269378 A1
(43) Pub. Date: Aug. 25, 2022

(54) Persistent State and Organization of Workspaces in User Interfaces

(71) Applicant: Shawn Joseph, Austin, TX (US)

(72) Inventor: Shawn Joseph, Austin, TX (US)

(21) Appl. No.: 17/392,145

(22) Filed: Aug. 2, 2021

Related U.S. Application Data
(60) Provisional application No. 63/163,595, filed on Mar. 19, 2021.
(60) Provisional application No. 63/163,900, filed on Mar. 21, 2021.
(60) Provisional application No. 63/153,087, filed on Feb. 24, 2021.
(60) Provisional application No. 63/154,565, filed on Feb. 26, 2021.
(60) Provisional application No. 63/161,742, filed on Mar. 16, 2021.
(60) Provisional application No. 63/189,223, filed on May 16, 2021.
(60) Provisional application No. 63/190,513, filed on May 19, 2021.
(60) Provisional application No. 63/194,991, filed on May 29, 2021.
(60) Provisional application No. 63/226,477, filed on Jul. 28, 2021.

(51) Int. Cl. G06F 3/0481; G06F 3/0484; G06F 9/451

(52) U.S. Cl. CPC G06F 3/0481; G06F 3/04845; G06F 9/451; G06F 2203/04803

(57) ABSTRACT

In some embodiments, a user may be able to open multiple windows in multiple locations. Locations may include various work area or work space configurations. In some embodiments, window/view configurations may be saved using various means to be preserved and re-used after a restart, reboot, login, or crash event. In some embodiments, not only will windows, tabs, and their contents be preserved and saved for re-opening, but also their specific locations and coordinates on a screen or GUI, and their respective virtual desktops will also be saved. In some embodiments, windows may be open from various different applications. In such cases, data representing and/or connecting applications and their corresponding windows may also be saved.

### CROSS REFERENCE TO RELATED APPLICATIONS

This application claims priority to, and the benefit of the filing date, of each of U.S. Provisional Application Ser. No. 63/163,595, filed Mar. 19, 2021, U.S. Provisional Application Ser. No. 63/163,900, filed Mar. 21, 2021, U.S. Provisional Application Ser. No. 63/153,087, filed Feb. 24, 2021, U.S. Provisional Application Ser. No. 63/154,565, filed Feb. 26, 2021, U.S. Provisional Application Ser. No. 63/161,742, filed Mar. 16, 2021, U.S. Provisional Application Ser. No. 63/189,223, filed May 16, 2021, U.S. Provisional Application Ser. No. 63/190,513, filed May 19, 2021, U.S. Provisional Application Ser. No. 63/194,991, filed May 29, 2021, and U.S. Provisional Application Ser. No. 63/226,477 filed Jul. 28, 2021.

The disclosures of the foregoing applications are incorporated herein by reference.

### TECHNICAL FIELD

This invention relates generally to graphical user interfaces (GUIs) and user interface states.

### SUMMARY

Embodiments include a method, system, and computer program product for persistent state configurations for graphical user interface (GUI) work areas and work spaces. In accordance with one or more embodiments, a computer implemented method may include a GUI that allows a user to be able to open multiple windows in multiple locations. Locations may include various virtual desktop configurations. In some embodiments, window configurations may be saved using various means to be preserved and re-used after a restart, reboot, login, or crash event. In some embodiments, not only will windows, tabs, and their contents be preserved and saved for re-opening, but also their specific locations and coordinates on a screen or GUI, and their respective virtual desktops will also be saved. In some embodiments, windows may be open from various different applications. In such cases, data representing and/or connecting applications and their corresponding windows may also be saved.

Other embodiments of this aspect include corresponding computer systems, apparatus, and computer programs recorded on one or more computer storage devices, each configured to perform one or more of the actions of the methods.

The details of one or more embodiments of the subject matter of this specification are set forth in the accompanying drawings and the description below. Other features, aspects, and advantages of the subject matter will become apparent from the description, the drawings, and the claims.

The subject matter described in this specification can be implemented in particular embodiments so as to realize one or more of the following advantages. Some examples of the advantages of the presented technology include new organizational capabilities, speed, efficiency, and/or security over present systems. In one example, the given system and methods allows users to quickly continue in a same or similar organizational state after a restart, reboot, login, or system crash event.

### BRIEF DESCRIPTION OF THE DRAWINGS

FIG. 1 is a diagram of a general network environment that can be used with graphical user interfaces (GUIs) and/or work spaces.

FIG. 2 is a first flowchart showing a state restoration process.

FIG. 3 is an example of a first state.

FIG. 4 is a second flowchart showing a state restoration data storage process.

FIG. 5 provides a flowchart showing one example restore/restart sequence.

FIG. 6 depicts a high-level block diagram of a computer system consistent with various embodiments of the present disclosure.

FIG. 7 shows an example embodiment that uses cloud infrastructure.

FIG. 8 shows an example embodiment that uses cloud infrastructure during a state restoration process.

### DETAILED DESCRIPTION

Acronyms

API—Application Programming Interface

HTTP/HTTPS—Hyper Text Transfer Protocol/Hyper Text Transfer Protocol Secure

ML—Machine Learning

P2P—Peer-to-Peer

REST—Representational State Transfer

TLS/SSL—Transport Layer Security/Secure Sockets Layer

VPC—Virtual Private Cloud

VPN—Virtual Private Network

Terminology

Application Programming Interface

API technologies provide routines, protocols, and tools for building software applications and specifies how software components should interact.

Cloud Computing

Cloud computing is a model that promotes ubiquitous, on-demand network access to shared computing.

Public Keys and Private Keys

Public and private keys are created in pairs for each entity involved in a transmission and encrypt and decrypt information during the initial part of the transmission so that only the sender and recipient of the transmission can decrypt and read the information. Public key is available to everyone while the private key is known only to the creator of the keys.

Transport Layer Security/Secure Sockets Layer (TLS/SSL)

Transport Layer Security/Secure Sockets Layer (TLS/SSL) connections make use of public and private keys among parties when establishing a connection and secure almost all transmissions over the internet or computer networks, including emails, web browsing, logins, and financial transactions, ensuring that all data that passes between a web server and a browser remains private and secure.

X.509 Certificates

X.509 certificates are digital certificates administered by certificate authorities that use the X.509 PKI standard to verify that a public key belongs to the user, computer, or service identity in the certificate and are used worldwide across public and private sectors.

X.509 Attribute Certificates

X.509 attribute certificates can encode attributes (such as name, date of birth, address, and unique identifier number), are attached cryptographically to the X.509 certificate, and are administered by attribute certificate authorities.

Hyper Text Transfer Protocol

It will be understood that the terms HTTP and HTTPS will be used interchangeably and that use of either term includes either alternative.

Representational State Transfer

Representational state transfer (REST) is a software architectural style that defines a set of constraints to be used for creating Web services. Web services that conform to the REST architectural style, called RESTful Web services, provide interoperability between computer systems on the Internet.

Virtual Private Networks

One element of a software service may be a Virtual Private Network (VPN). A VPN may establish a secure and private tunnel from a network, terminal, or device, for example to another network element such as a vendor service, for example.

Security Groups

One element of a software service may be a security group. A security group, rules may be defined that dictate the allowed inbound and/or outbound traffic to a server, for example. For example, a security rule may specify to allow SSH access, from a particular IP address, on a particular port or port range, and using a particular protocol, such as TCP.

Virtual Private Cloud

One element of a software service may be a Virtual Private Cloud (VPC). A VPC allows isolation of shared cloud resources, for example. In one method, private IP subnets may be assigned to a VPC user that is accompanied by a VPN function or access that secures, by means of authentication and encryption, the user's VPC resources.

Queues

One element of a software service may be a processing queue. For example, the queue may be processed in a first-in-first-out (FIFO) or last-in-first-out (LIFO) order. The queue may collect several processes to be carried out.

Server Architecture

A software service may be hosted on elastic server architecture, in one example. In an elastic architecture, computing resources may be automatically increased or decreased to meet computing needs. Computing thresholds may be preset or configured. When a threshold is exceeded for example, additional computing resources may be allocated.

Serverless Architecture

In another example, a software service may be hosted using serverless architecture. In a serverless architecture, computing resources are allocated as necessary on a per-request basis. After the request is processed, the computing resources are unallocated, or returned.

Data Structures

Various data structures may be used in conjunction with the software services. For example, various data structures may be used alone, or in combination, to store customer data/metadata, transaction data, etc.

Some example data structures include arrays, stacks, queues, linked lists, trees, graphs, tries, and hash tables.

Software Services

A third party vendor or provider may provide virtual currency processing software services. Software may be installed on terminals or via backend/cloud servers, or both.

Other Terminology

Herein a “plurality” refers to “one or more” of an element and does not impose any requirement for more than one element.

Various services may be pipelined, and executed in conjunction, in a non-blocking manner, for example.

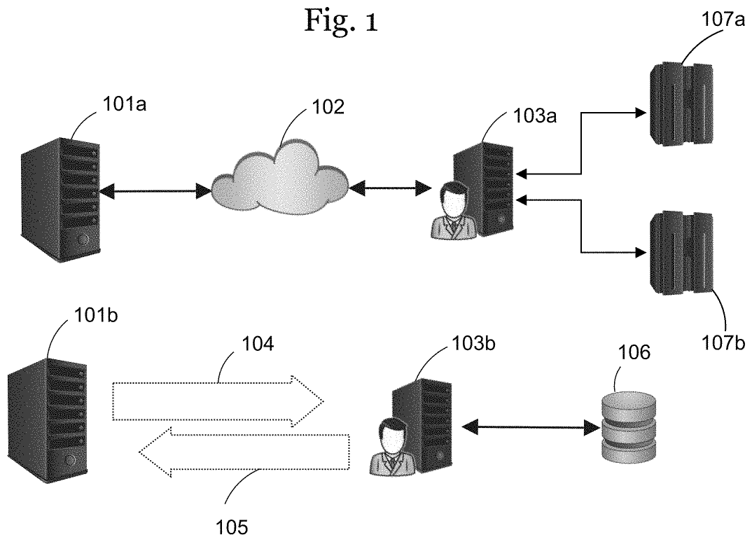

FIG. 1 is a diagram of a general network environment that can be used with clients. A client, 101a or 101b, for example, may be in communication through a network 102 with a backend service, 103a or 103b, hosted by a software service provider, for example. The client may send requests 104 through the network 102 to the service 103a or 103b. The service may determine a response 105 using information and data from a datastore 106, for example. The response 105 may be sent to the client instructing certain actions, for example. The backend service may be in further communication with third party services, 107a or 107b, for example.

With the advent of mobile and/or complex computing systems, many detailed problems and inefficiencies arise. One such problem is related to organization and presentation of information in, for example, graphical user interfaces (GUIs).

In some embodiments, a user may be able to open multiple windows in multiple locations. Locations may include various virtual desktop configurations.

However, if a user cannot pick up where he left off, organizationally, after, for example, a restart or reboot event (sometimes unexpectedly, such as during a crash event) of the machine or client device displaying the, then much time may be lost.

In some embodiments, window configurations may be saved using various means to be preserved and re-used after a restart, reboot, or crash event.

In some embodiments, not only will windows, tabs, and their contents be preserved and saved for re-opening, but also their specific locations and coordinates on a screen or GUI, and their respective virtual desktops will also be saved.

In some embodiments, windows may be open from various different applications. In such cases, data representing and/or connecting applications and their corresponding windows may also be saved.

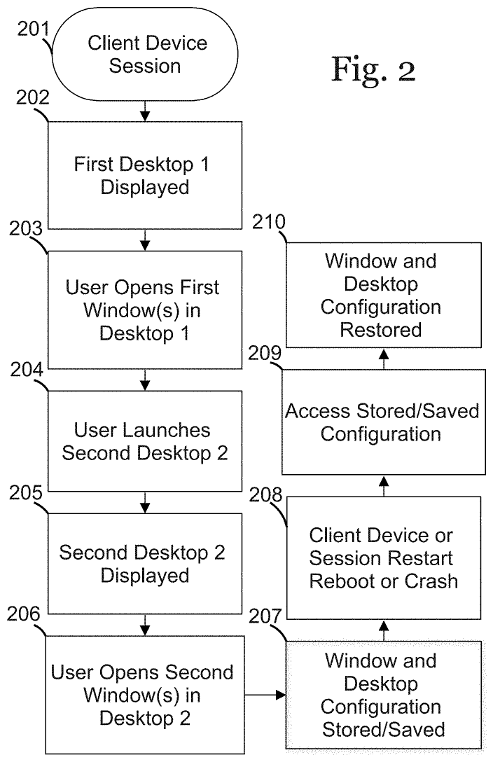

FIG. 2 is a first flowchart showing a state restoration process. In one example embodiment, during a user client device session 201, a first desktop space “Desktop 1” is displayed 202. The user may open a first window in Desktop 1, 203. The user may launch a second desktop space, “Desktop 2,” 204. In response, a second desktop, “Desktop 2,” may be displayed 205. The user may open a second window in Desktop 2, 206. In response to the desktop and window configuration created, selected, or arranged by the user, a window and desktop space state configuration may be stored/saved 207, for example, in a local file and/or communicated to a cloud service storage location. In one example, window and/or window tab positions and/or coordinates may be saved and mapped to particular desktops and/or virtual workspaces. The client device may be restarted, rebooted, and/or the system/session may crash 208. Upon a restart or restore event, the stored information may be accessed 209. Using the stored configuration data, the previous desktop and window state may be restored 210.

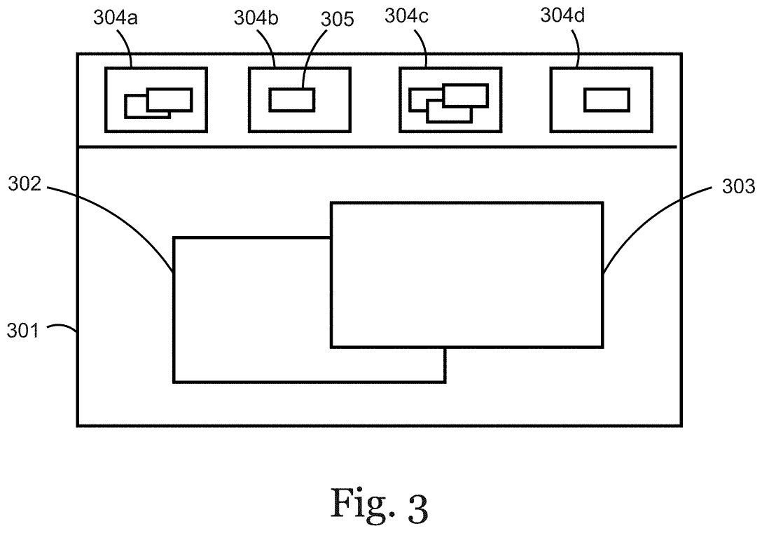

FIG. 3 is an example of a first state, including user view of a first desktop or virtual desktop 301 and miniature or thumbnail views of additional desktops or virtual desktops (304a-304d). For example, a miniature or thumbnail view of first virtual desktop “Desktop 1” is shown in 304a. A first desktop or virtual desktop 301 may display a first browser window “Window 1” (302) in a first location in “Desktop 1,” and a miniature or thumbnail view of a second virtual desktop “Desktop 2”(304b) may display a second browser window “Window 2” (305) in a second location in “Desktop 2.” Upon or after a restart, reboot, or crash event, a first virtual desktop “Desktop 1” may be reopened and/or displayed with a same first browser window “Window 1” in a same first location in “Desktop 1,” and a second virtual desktop “Desktop 2” may reopened and/or displayed with a same second browser window “Window 2” in a same second location in “Desktop 2.” Thus, an original state or configuration of GUI elements may be restored to a state that is the same or similar to before a restart, reboot, or crash event. Current systems do not permit such restoration and therefore much organizational time and energy is lost and/or often needs to be reinvested.

In some embodiments, a user may be allowed to provide or enter his own naming conventions for each desktop or virtual desktop. For example, a user may utilize a naming convention that allows additional organization, such as “Project 1.”

In some embodiments, an indicator, such as an icon, may be displayed, for example, along with the name of a desktop to indicate a state or characteristic associated with the respective desktop. For example, a speaker icon may be displayed with a desktop name to indicate that sound is originating or present for an application or window associated, or open in, the respective desktop. This allows a user to easily determine that sound is originating from the given desktop to, for example, be able to close the application if sound is unwanted.

In some embodiments, users may be allowed to provide configuration or preferences such as expiration times or periods after which windows or applications may automatically close or no longer be opened automatically.

In some embodiments, data may be saved to a file such as a property list (.plist) file or database related (.db) file. In some examples a property list file may be in binary or XML formats. A file such as a property list file, for example, may be read upon a restart or login event, for example. The file may contain data to allow restoration of a previous state including, for example, a state of windows and desktops.

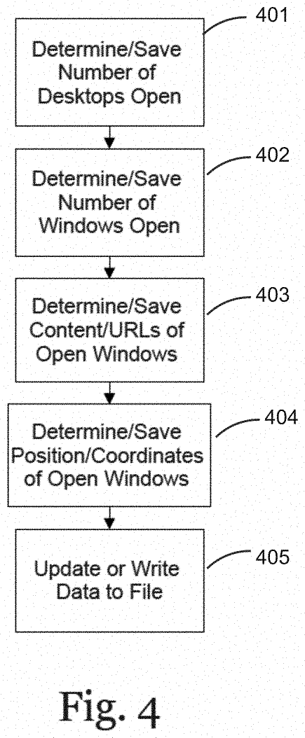

FIG. 4 is a second flowchart showing a state restoration data storage process. The system may determine and/or save a number of desktops and/or virtual workspaces that are open 401. The system may also determine and/or save a number of windows open in each of the spaces 402. The system may also determine and/or save the content, location, or URLs of the windows open in each of the spaces 403. The system may also determine and/or save the positions and/or coordinates of the windows open in each of the spaces 404. Any or all of the data may be updated, saved, or stored to a local file and/or cloud storage file, for example, 405.

Examples of data that may be stored to allow restoration of a previous view state include a number of desktops or virtual desktops open, the desktop or virtual desktop in focus, windows and/or tabs open in each, URLs for open browser tabs, applications GUIs that are open, window or applications GUIs locations and/or coordinates (such as x, y, or z coordinates or strings including size and location value elements), window and/or applications GUI sizes, and/or window or applications GUI contents. In some cases, for example, a reference point and a size may be used. For example, an upper left pixel location and window size, along with a desktop or virtual desktop identifier, may be sufficient to restore a window position. In some cases a z-coordinate or z-index, for example, may be stored in order to determine a “top” window or applications GUI that is in focus. In another example, an origin or reference point may be defined and size and location of a window or view may be defined by unit distance (such as 1 pixel) from the reference point. For example, a size and location of a window or view might be stored as a property string such as “{74, 94, 514, 485}”. The property may be a four-item list of integers representing the area of a window. In one example, the four list items are described below:

List item 1, “74”:

The distance in pixels from the left side of the screen to the left side of the window or view.

List item 2, “94”:

The distance in pixels from the top of the screen to the top of the window or view.

List item 3, “514”:

The distance in pixels from the left side of the screen to the right side of the window or view.

List item 4, “485”:

The distance in pixels from the top of the screen to the bottom of the window or view.

In some embodiments, several versions or data sets may be saved for various time points. For example, a property list file may be created or updated with a data set including state data at some interval including date/timestamps. For example, a data set may be created, stored, or written every 10 minutes. In some embodiments, data sets may be updated in response to state changes. For example, when a user repositions a window, window coordinates may be recalculated or determined and a state data set updated to reflect the change or delta. In some embodiments, a delta may be stored at some interval. In some embodiments, during a restore event, a system may determine a most recent chronological data set for restoration. In some cases, if a most recent data set is corrupted, unreadable, unusable, or unavailable, a system may determine a next most recent chronological data set for restoration, and repeat until a usable data set is found or determined. In some cases, if no such data set is found, a default state may be used. In some embodiments, a user may be given controls or abilities to select a date and/or time for restoration from a set of available data sets. In such cases, a restoration may be performed according to the user's selection. In some cases, different files may be created, stored, updated, and or maintained for different users of a client device, such as a laptop. This allows state and/or configurations to be saved for various users. A state may be restored according to the user that is logging in, or logged in. In some embodiments, users may be allowed to enable or disable restoration and/or reopening functionality for himself, or for all users, during login, for example.

In some embodiments, data sets may be compressed, encrypted, and/or stored or delivered to various locations, for example, to a hardware cache or cloud service for storage.

In some embodiments, data sets stored in a cloud service may be accessed upon a user's login at another location or from a new device. The data sets may be used to restore a session as described herein.

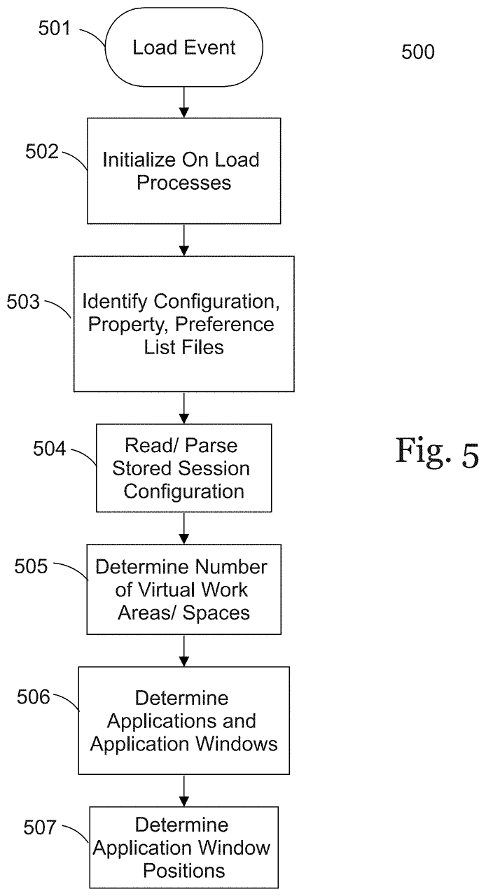

FIG. 5 provides a flowchart showing one example restore/restart sequence 500. After a system restarts, crashes, reboots, etc., a load event occurs 501. The load event initializes stored load processes/instructions 502, for example. In some example embodiments, stored load processes/instructions may be stored in local files or cloud files, such as preference or property list files that define a first state, which may be identified 503. In one example, Application A (such as Google Chrome browser) may be running in two windows or views, and Window/View 1 may be open in Desktop 1 and Window/View 2 may be open in Desktop 2. This configuration may be associated with a first state.

From the stored files, configuration preferences and/or state information files may be parsed/read 504. A number of areas or work spaces in a previous state before the restart/crash event may be determined from stored file information 505. Applications open or being used in a previous state before the restart/crash event may be determined from stored file information 506. Application windows or views associated with each application in a previous state before the restart/crash event may be determined from stored file information 507. Using the stored configuration, the aforementioned first state may be restored and/or replicated. It will be noted that various applications may be running, each with various windows/views in various virtual work areas or work spaces. Any or all of the data may be stored as state information along with window/view position definitions or data.

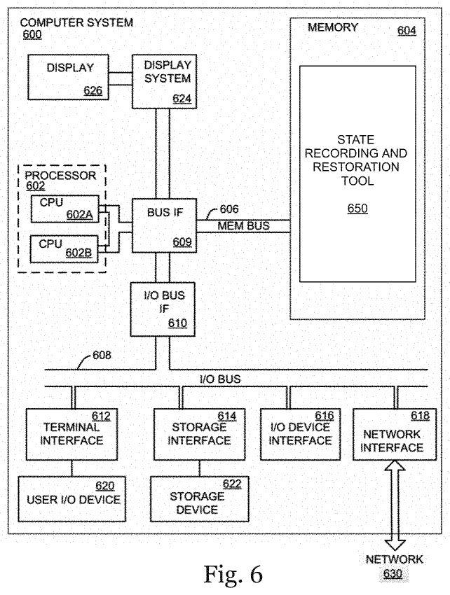

FIG. 6 depicts a high-level block diagram of a computer system 600 consistent with various embodiments of the present disclosure. The mechanisms and apparatus of the various embodiments disclosed herein apply equally to any appropriate computing system. The major components of the computer system 600 include one or more processors 602, a memory 604, a terminal interface 612, a storage interface 614, an I/O (Input/Output) device interface 616, and a network interface 618, all of which are communicatively coupled, directly or indirectly, for inter-component communication via a memory bus 606, an I/O bus 608, bus interface unit 609, and an I/O bus interface unit 610.

The computer system 600 may contain one or more general-purpose programmable central processing units (CPUs) 602A and 602B, herein generically referred to as the processor 602. In embodiments, the computer system 600 may contain multiple processors; however, in certain embodiments, the computer system 600 may alternatively be a single CPU system. Each processor 602 executes instructions stored in the memory 604 and may include one or more levels of on-board cache.

In embodiments, the memory 604 may include a random-access semiconductor memory, storage device, or storage medium (either volatile or non-volatile) for storing or encoding data and programs. In certain embodiments, the memory 604 represents the entire virtual memory of the computer system 600, and may also include the virtual memory of other computer systems coupled to the computer system 600 or connected via a network. The memory 604 can be conceptually viewed as a single monolithic entity, but in other embodiments the memory 604 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The memory 604 may store all or a portion of the various programs, modules and data structures for processing data transfers as discussed herein. For instance, the memory 604 can store state recording and/or state restoration tools or modules 650. Consistent with certain embodiments, these tools can be implemented as part of one or more monitor threads. These programs and data structures are illustrated as being included within the memory 604 in the computer system 600, however, in other embodiments, some or all of them may be on different computer systems and may be accessed remotely, e.g., via a network. The computer system 600 may use virtual addressing mechanisms that allow the programs of the computer system 600 to behave as if they only have access to a large, single storage entity instead of access to multiple, smaller storage entities. Thus, while the tools 650 are illustrated as being included within the memory 604, these components are not necessarily all completely contained in the same storage device at the same time. Further, although the tools 650 are illustrated as being separate entities, in other embodiments some of them, portions of some of them, or all of them may be packaged together (e.g., as part of the same monitor thread).

In embodiments, the tools 650 may include instructions or statements that execute on the processor 602 or instructions or statements that are interpreted by instructions or statements that execute on the processor 602 to carry out the functions as further described below. In certain embodiments, the tools 650 can be implemented in hardware via semiconductor devices, chips, logical gates, circuits, circuit cards, and/or other physical hardware devices in lieu of, or in addition to, a processor-based system. In embodiments, the tools 650 may include data in addition to instructions or statements.

The computer system 600 may include a bus interface unit 609 to handle communications among the processor 602, the memory 604, a display system 624, and the I/O bus interface unit 610. The I/O bus interface unit 610 may be coupled with the I/O bus 608 for transferring data to and from the various I/O units. The I/O bus interface unit 610 communicates with multiple I/O interface units 612, 614, 616, and 618, which are also known as I/O processors (IOPs) or I/O adapters (IOAs), through the I/O bus 608. The display system 624 may include a display controller, a display memory, or both. The display controller may provide video, audio, or both types of data to a display device 626. The display memory may be a dedicated memory for buffering video data. The display system 624 may be coupled with a display device 626, such as a standalone display screen, computer monitor, television, or a tablet or handheld device display. In one embodiment, the display device 626 may include one or more speakers for rendering audio. Alternatively, one or more speakers for rendering audio may be coupled with an I/O interface unit. In alternate embodiments, one or more of the functions provided by the display system 624 may be on board an integrated circuit that also includes the processor 602. In addition, one or more of the functions provided by the bus interface unit 609 may be on board an integrated circuit that also includes the processor 602.

The I/O interface units support communication with a variety of storage and I/O devices. For example, the terminal interface unit 612 supports the attachment of one or more user I/O devices 620, which may include user output devices (such as a video display device, speaker, and/or television set) and user input devices (such as a keyboard, mouse, keypad, touchpad, trackball, buttons, light pen, or other pointing device). A user may manipulate the user input devices using a user interface, in order to provide input data and commands to the user I/O device 620 and the computer system 600, and may receive output data via the user output devices. For example, a user interface may be presented via the user I/O device 620, such as displayed on a display device, played via a speaker, or printed via a printer.

The storage interface 614 supports the attachment of one or more disk drives or direct access storage devices 622 (which are typically rotating magnetic disk drive storage devices, although they could alternatively be other storage devices, including arrays of disk drives configured to appear as a single large storage device to a host computer, or solid-state drives, such as flash memory). In some embodiments, the storage device 622 may be implemented via any type of secondary storage device. The contents of the memory 604, or any portion thereof, may be stored to and retrieved from the storage device 622 as needed. The I/O device interface 616 provides an interface to any of various other I/O devices or devices of other types, such as printers or fax machines. The network interface 618 provides one or more communication paths from the computer system 600 to other digital devices and computer systems; these communication paths may include, e.g., one or more networks 630.

Although the computer system 600 shown in FIG. 6 illustrates a particular bus structure providing a direct communication path among the processors 602, the memory 604, the bus interface 609, the display system 624, and the I/O bus interface unit 610, in alternative embodiments the computer system 600 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 610 and the I/O bus 608 are shown as single respective units, the computer system 600 may, in fact, contain multiple I/O bus interface units 610 and/or multiple I/O buses 608. While multiple I/O interface units are shown, which separate the I/O bus 608 from various communications paths running to the various I/O devices, in other embodiments, some or all of the I/O devices are connected directly to one or more system I/O buses.

In various embodiments, the computer system 600 is a multi-user mainframe computer system, a single-user system, or a server computer or similar device that has little or no direct user interface, but receives requests from other computer systems (clients). In other embodiments, the computer system 600 may be implemented as a desktop computer, portable computer, laptop or notebook computer, tablet computer, pocket computer, telephone, smart phone, or any other suitable type of electronic device.

FIG. 6 depicts a representative of certain major components of the computer system 600. Individual components, however, may have greater complexity than represented in FIG. 6, components other than or in addition to those shown in FIG. 6 may be present, and the number, type, and configuration of such components may vary. Several particular examples of additional complexity or additional variations are disclosed herein; these are by way of example only and are not necessarily the only such variations. The various program components illustrated in FIG. 6 may be implemented, in various embodiments, in a number of different manners, including using various computer applications, routines, components, programs, objects, modules, data structures, etc., which may be referred to herein as “software,” “computer programs,” or simply “programs.”

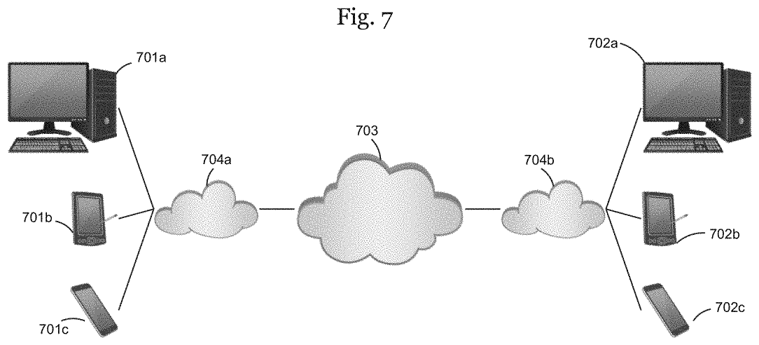

FIG. 7 shows an example embodiment that uses cloud infrastructure. A first set of one or more client devices (701a-701c) may exist in a first area or location, for example in a user's home. A second set of one or more client devices (702a-702c) may exist in a second area or location, for example in a user's work location or office. The first set of devices and second set of devices may be in communication or connected to each other through a cloud network (703, 704a, 704b), for example. A centralized cloud storage location 703 may be connected with edge storage locations 704a-704b.

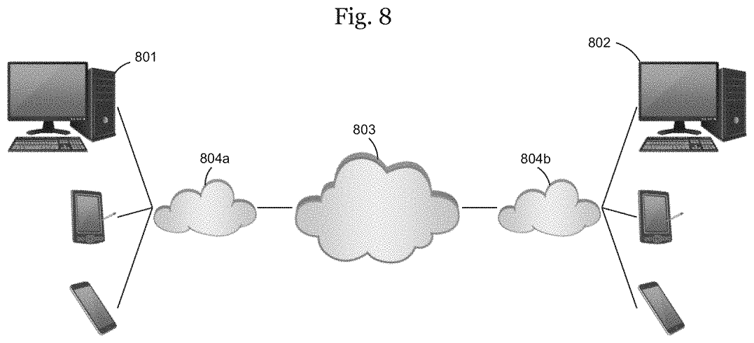

FIG. 8 shows an example embodiment that uses cloud infrastructure similar to FIG. 7. A user may establish or create a user session at client device 801 in a first location. A first state and/or configuration may be determined, updated, and/or saved to one or more local and/or cloud files/locations. In some embodiments, updates may be carried out in one or more locations. For example, updates may be made more frequently in edge locations such as 804a than in central locations 804. Upon a user login at a different location on a different device 802, the previous state at device 801 may be replicated using stored state information.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the embodiments and/or following claims.

Example embodiments are provided:

It will be understood that any of the given elements, steps, etc. in the given embodiments are optional and or reorderable, and provided for example embodiment purposes only.
1. A method or system configured to perform a method, the method comprising one or more components of the following:

determining a first state, wherein determining the first state comprises:
receiving one or more instructions allowing a first login by a first user;
receiving one or more instructions to open at least a first virtual desktop;
receiving one or more instructions to open at least a second virtual desktop;
receiving one or more instructions to open at least a first application GUI or window in the first virtual desktop;

receiving one or more instructions to open at least a second application GUI or window in the second virtual desktop;

creating, modifying, updating, and/or storing a first data set reflecting a first state or configuration in a first memory storage device and/or file:
wherein the file comprises a property list file, wherein the property list file is formatted in a binary or XML format;
wherein the first data set comprises:
   first position data for the first application GUI or window in the first virtual desktop;
   first association data linking or connecting the first application GUI or window with the first virtual desktop;
   first application association data linking or connecting the first application GUI or window with the first application;
   second position data for the second application GUI or window in the second virtual desktop;
   second association data linking or connecting the second application GUI or window with the second virtual desktop;
   second application association data linking or connecting the second application GUI or window with the second application;

determining or receiving a restart, roboot, crash, login or access event; after determining or receiving a restart, roboot, crash, login or access event, receiving one or more instructions allowing a second login by the first user;

in response to the second login by the first user, accessing or reading the first data set reflecting the first state or configuration in a first memory storage device and/or file:

based on the first data set, performing a restoring to the first state or configuration or a second state reflecting the first state or configuration or produce a restored state, wherein the restored state comprises:
a first restored virtual desktop;
a second restored virtual desktop;
a first restored application GUI or window in the first restored virtual desktop;
a second restored application GUI or window in the second restored virtual desktop;
wherein restored positions of the first restored application GUI or window in the first restored virtual desktop and the second restored application GUI or window in the second restored virtual desktop are the same or analogous to first state positions of the first application GUI or window in the first virtual desktop and the second application GUI or window in the second virtual desktop;

2. A method or system configured to perform a method, the method comprising one or more components of the following:

determining a first state, wherein determining the first state comprises:
receiving one or more instructions allowing a first login by a first user;
receiving one or more instructions to open at least a first virtual desktop;
receiving one or more instructions to open at least a second virtual desktop;
receiving one or more instructions to open at least a first application GUI or window in the first virtual desktop;
receiving one or more instructions to open at least a second application GUI or window in the first virtual desktop;
receiving one or more instructions to open at least a third application GUI or window in the second virtual desktop;

creating, modifying, updating, and/or storing a first data set reflecting a first state or configuration in a first memory storage device and/or file:
wherein the file comprises a property list file, wherein the property list file is formatted in a binary or XML format;
wherein the first data set comprises:
   information indicating an event date and/or time;
   first position data for the first application GUI or window in the first virtual desktop;
   first association data linking or connecting the first application GUI or window with the first virtual desktop;
   wherein the first position data comprises:
      a first x-index or x-coordinate;
      a first y-index or y-coordinate;
      a first z-index or z-coordinate;
   second position data for the second application GUI or window in the first virtual desktop;
   second association data linking or connecting the second application GUI or window with the first virtual desktop;
   wherein the second position data comprises:
      a second x-index or x-coordinate;
      a second y-index or y-coordinate;
      a second z-index or z-coordinate;
   third position data for the third application GUI or window in the second virtual desktop;
   third association data linking or connecting the third application GUI or window with the second virtual desktop;
   wherein the third position data comprises:
      a third x-index or x-coordinate;
      a third y-index or y-coordinate;
      a third z-index or z-coordinate;
receiving first changes associated with one or more instructions to adjust, reposition, or move at least the first application GUI or window in the first virtual desktop, and in response, recalculating the first position data:
   updating the information indicating an event date and/or time with an updated event time to reflect the first changes;
   updating the first x-index or x-coordinate;
   updating the first y-index or y-coordinate;
   updating the first z-index or z-coordinate;
receiving second changes associated with one or more instructions to adjust, reposition, or move at least the second application GUI or window in the first virtual desktop, and in response, recalculating the second position data:
   updating the information indicating an event date and/or time with an updated event time to reflect the second changes;
   updating the second x-index or x-coordinate;
   updating the second y-index or y-coordinate;
   updating the second z-index or z-coordinate;
receiving third changes associated with one or more instructions to adjust, reposition, or move at least the third application GUI or window in the second virtual desktop, and in response, recalculating the third position data:
   updating the information indicating an event date and/or time with an updated event time to reflect the third changes;
   updating the third x-index or x-coordinate;
   updating the third y-index or y-coordinate;
   updating the third z-index or z-coordinate;

updating the first data set reflecting a second state or configuration in a first memory storage device and/or file:

determining or receiving a restart, roboot, crash, login or access event;

after determining or receiving a restart, roboot, crash, login or access event, receiving one or more instructions allowing a second login by the first user;

in response to the second login by the first user, accessing or reading the first data set reflecting the second state or configuration in a first memory storage device and/or file:

based on the first data set, performing a restoring to the first state or configuration or a second state reflecting the first state or configuration or produce a restored state, wherein the restored state comprises:
a first restored virtual desktop;
a second restored virtual desktop;
a first restored application GUI or window in the first restored virtual desktop;
a second restored application GUI or window in the second restored virtual desktop;
wherein restored positions of the first restored application GUI or window in the first restored virtual desktop and the second restored application GUI or window in the second restored virtual desktop are the same or analogous to first state positions of the first application GUI or window in the first virtual desktop and the second application GUI or window in the second virtual desktop;
3. A method, computer readable medium storing instructions, or system configured to perform a method as in Embodiment 1 or 2, wherein the first memory storage device and/or file is a local file.
4. A method, computer readable medium storing instructions, or system configured to perform a method as in Embodiment 1 or 2, wherein the first memory storage device and/or file is a cloud storage file.
5. A method, computer readable medium storing instructions, or system configured to perform a method as in Embodiment 4, wherein the updating comprises:

delivering the file to a cloud service via an HTTP/HTTPS request.
6. A method performed by one or more processors executing on a computer system, the method comprising:

determining a first state, wherein determining the first state comprises:
receiving one or more instructions allowing a first login action by a first user;
receiving one or more instructions to open at least a first user interface work area;
receiving one or more instructions to open at least a second user interface work area;
receiving one or more instructions to open at least a first application window or view in the first user interface work area;
receiving one or more instructions to open at least a second application window or view in the second user interface work area;
7. The method of Embodiment 6, further comprising:

creating, modifying, updating, and/or storing a first data set reflecting a first state or configuration in a first memory storage device and/or file:
wherein the file comprises a property or preference file;
8. The method of Embodiment 7, further comprising:

wherein the first data set comprises:
first position data for the first application window or view in the first user interface work area;
first association data linking or connecting the first application window or view with the first user interface work area;
first application association data linking or connecting the first application window or view with with the first application;
second position data for the second application window or view in the second user interface work area;
second association data linking or connecting the second application window or view with the second user interface work area;
second application association data linking or connecting the second application window or view with the second application;
9. The method of Embodiment 8, further comprising:

determining, detecting, or receiving a restart, roboot, or crash event;
10. The method of Embodiment 9, further comprising:

after determining, detecting, or receiving the restart, roboot, or crash event, receiving one or more instructions allowing a second login action by the first user;

in response to the second login action by the first user, accessing or reading the first data set reflecting the first state or configuration in the first memory storage device and/or file;
11. The method of Embodiment 10, further comprising:

based on the accessing or reading the first data set reflecting the first state or configuration, performing a restoring to a first restored state reflecting the first state or configuration;
12. The method of Embodiment 11, further comprising:

wherein the first restored state comprises:
a first restored user interface work area;
a second restored user interface work area;
a first restored application window or view in the first restored user interface work area;
a second restored application window or view in the second restored user interface work area;
13. The method of Embodiment 12, further comprising:

wherein a first restored position of the first restored application window or view in the first restored user interface work area is the same or analogous to a first state position of the first application window or view in the first user interface work area; and

wherein a second restored position of the second restored application window or view in the second restored user interface work area is the same or analogous to a second state position of the second application window or view in the second user interface work area.
14. A non-transitory computer-readable storage medium storing instructions that, when executed, generate on a display device a graphical user interface for presenting virtual workspaces and perform operations according to any of Embodiments 6-13.
20. A system comprising:
   a display device; and
   a computing device in communication with the display device, wherein the computing device is capable of performing operations according to any of Embodiments 6-13.
16. A method performed by one or more processors executing on a computer system, the method comprising:

determining a first state, wherein determining the first state comprises:
receiving one or more instructions allowing a first login action by a first user;
receiving a first set of one or more instructions to open at least a first user interface work area;
receiving a second set of one or more instructions to open at least a second user interface work area;
receiving a this set one or more instructions to open at least a first application window or view in the first user interface work area;
receiving one or more instructions to open at least a second application window or view in the first user interface work area;
receiving one or more instructions to open at least a third application window or view in the second user interface work area;
17. The method of Embodiment 16, further comprising:

creating, modifying, updating, and/or storing a first data set reflecting a first state or configuration in one or more files in a first memory storage device;
18. The method of Embodiment 17, further comprising:
   wherein the one or more files comprise a property or preference file;
19. The method of Embodiment 18, further comprising:
   wherein the first data set comprises:
      information indicating an event date and/or time;
      first position data for the first application window or view in the first user interface work area;
      first association data linking or connecting the first application window or view with the first user interface work area;
      wherein the first position data comprises:
         a first set of values defining, using a coordinate system, a first location and a first size of the first application window or view in the first user interface work area;
      second position data for the second application window or view in the first user interface work area;
      second association data linking or connecting the second application window or view with the first user interface work area;
      wherein the second position data comprises:
         a second set of values defining, using the coordinate system, a second location and a second size of the second application window or view in the first user interface work area;
      third position data for the third application window or view in the second user interface work area;
      third association data linking or connecting the third application window or view with the second user interface work area;
      wherein the third position data comprises:
         a third set of values defining, using the coordinate system, a third location and a third size of the third application window or view in the second user interface work area;
20. The method of Embodiment 19, further comprising:

receiving first changes associated with one or more instructions to adjust, reposition, or move at least the first application window or view in the first user interface work area;

in response to receiving the first changes associated with one or more instructions to adjust, reposition, or move at least the first application window or view in the first user interface work area, recalculating or updating the first position data to produce updated first position data, wherein recalculating or updating the first position data comprises:
updating the information indicating an event date and/or time with an updated event time;
updating the first set of values defining, using the coordinate system, the first location and the first size of the first application window or view in the first user interface work area;

receiving second changes associated with one or more instructions to adjust, reposition, or move at least the second application window or view in the first user interface work area;

in response to receiving the second changes associated with one or more instructions to adjust, reposition, or move at least the second application window or view in the first user interface work area, recalculating or updating the second position data to produce updated second position data, wherein recalculating or updating the second position data comprises:
updating the information indicating an event date and/or time with an updated event time;
updating the second set of values defining, using the coordinate system, the second location and the second size of the second application window or view in the first user interface work area;

receiving third changes associated with one or more instructions to adjust, reposition, or move at least the third application window or view in the second user interface work area;

in response to receiving the third changes associated with one or more instructions to adjust, reposition, or move at least the third application window or view in the second user interface work area, recalculating or updating the third position data to produce updated third position data, wherein recalculating or updating the third position data comprises:
updating the information indicating an event date and/or time with an updated event time;
updating the third set of values defining, using the coordinate system, the third location and the third size of the third application window or view in the second user interface work area;

wherein the updated first position data, the updated second position data, and the updated third position data reflect a second state or configuration;
21. The method of Embodiment 20, further comprising:

determining, detecting, or receiving a restart, roboot, or crash event;

after determining, detecting, or receiving the restart, roboot, or crash event, receiving one or more instructions allowing a second login by the first user;

in response to the second login by the first user, accessing or reading, from the one or more files in the first memory storage device, the updated first position data, the updated second position data, and the updated third position data;
22. The method of Embodiment 21, further comprising:

based on the first data set, performing a restoring to the second state or configuration reflecting the first state or configuration to produce a restored state, wherein the restored state comprises:
a first restored user interface work area;
a second restored user interface work area;
a first restored application window or view in the first restored user interface work area;
a second restored application window or view in the first restored user interface work area;
a third restored application window or view in the second restored user interface work area;
23. The method of Embodiment 22, further comprising:

wherein a first restored position of the first restored application window or view in the first restored user interface work area is the same or analogous to a first state position of the first application window or view in the first user interface work area;

wherein a second restored position of the second restored application window or view in the second restored user interface work area is the same or analogous to a second state position of the second application window or view in the second user interface work area; and

wherein a third restored position of the third restored application window or view in the second restored user interface work area is the same or analogous to a first state position of the third application window or view in the second user interface work area.
24. The method of Embodiment 23, further comprising:
   wherein the first data set comprises:
      first position data for the first application window or view in the first user interface work area;
      second position data for the second application window or view in the first user interface work area;
      third position data for the third application window or view in the second user interface work area;
      third association data linking or connecting the third application window or view with the second user interface work area;

receiving first changes associated with one or more instructions to adjust, reposition, or move at least the first application window or view in the first user interface work area;

in response to receiving the first changes associated with one or more instructions to adjust, reposition, or move at least the first application window or view in the first user interface work area, recalculating or updating the first position data to produce updated first position data;

wherein the updated first position data, the second position data, and the third position data reflect a second state or configuration;

determining, detecting, or receiving a restart, roboot, or crash event;

after determining, detecting, or receiving a restart, roboot, or crash event, receiving one or more instructions allowing a second login by the first user;

in response to the second login by the first user, accessing or reading, from the one or more files in the first memory storage device, the updated first position data, the second position data, and the third position data;
25. The method of Embodiment 24, further comprising:

performing a restoring to the second state or configuration reflecting the first state or configuration to produce a restored state, wherein the restored state comprises:
a first restored user interface work area;
a second restored user interface work area;
a first restored application window or view in the first restored user interface work area;
a second restored application window or view in the first restored user interface work area;
a third restored application window or view in the second restored user interface work area;
26. The method of any of Embodiments 6-25, further comprising:

wherein the first user interface work area comprises a first virtual workspace, the second user interface work area comprises a second virtual workspace, and the third user interface work area comprises a third virtual workspace.
27. The method of Embodiment 26, further comprising:

wherein the first virtual workspace may be visible while the second virtual workspace is not visible and while the third virtual workspace is not visible.
28. The method of any of Embodiments 26-27, further comprising:

wherein the second virtual workspace may be visible while the first virtual workspace is not visible and while the third virtual workspace is not visible.
29. The method of any of Embodiments 26-28, further comprising:

wherein the third virtual workspace may be visible while the first virtual workspace is not visible and while the second virtual workspace is not visible.
30. The method of any of Embodiments 26-29, further comprising:
receiving a user selection of the first virtual workspace to be visible.
31. The method of any of Embodiments 26-30, further comprising:

in response to the user selection of the first virtual workspace to be visible, displaying the first virtual workspace while not displaying the second virtual workspace and while not displaying the third virtual workspace.
32. The method of any of Embodiments 26-31, further comprising:

receiving a user selection of one virtual workspace to be visible.
33. The method of any of Embodiments 26-32, further comprising:

in response to the user selection of the one virtual workspace to be visible, displaying the first virtual workspace while not displaying unselected virtual workspaces.
34. The method of any of Embodiments 26-33, further comprising:

wherein the user may switch or toggle between virtual workspaces
35. The method of any of Embodiments 26-34, further comprising:

wherein the virtual workspaces are displayed one at a time or separately to occupy a full screen of a user device.
36. A system comprising: a display device; and a computing device in communication with the display device, wherein the computing device is capable of performing the method of any of Embodiments 6-35.

The above processes/steps are merely examples. Various combinations of the above processes/steps are possible.

1-20. (canceled)

21. A method performed by one or more processors executing on a computer system, the method comprising:
receiving one or more instructions allowing a first login action by a first user at a first client device;
receiving one or more instructions to launch or open a first desktop;
receiving one or more instructions to launch or open a second desktop;
receiving one or more instructions to open a first application window on the first desktop;
receiving one or more instructions to open a second application window on the second desktop;
displaying a first user view, the first user view comprising:
a first thumbnail view of the first desktop;
a second thumbnail view of the second desktop;
wherein, the first thumbnail view of the first desktop comprises:
a first miniature view of the first application window at a first position on the first desktop;
wherein, the second thumbnail view of the second desktop comprises:
a second miniature view of the second application window at a second position on the second desktop;
storing a first data set reflecting a first state or configuration in a first memory storage device;
wherein the first data set comprises:
first position data for the first application window on the first desktop;
wherein the first position data comprises:
a first set of values defining a first location and a first size of the first application window on the first desktop;
second position data for the second application window on the second desktop;
wherein the second position data comprises:
a second set of values defining a second location and a second size of the second application window or view on the second desktop.

22. The method of claim 21, further comprising:
delivering the first data set to a first cloud storage.

23. The method of claim 22, further comprising:
receiving one or more instructions allowing a second login action by the first user at a second client device.

24. The method of claim 23, further comprising:
accessing the first data set in the first cloud storage from the second client device to restore a session.

25. The method of claim 24, further comprising:
in response to a state change, determining a second data set comprising updated state data;
wherein the state change comprises the first user repositioning the first window;
wherein the determining a second data set comprising updated state data comprises recalculating the first window position on the first desktop.

26. The method of claim 21, further comprising:
in response to a state change, determining a second data set comprising updated state data;
wherein the state change comprises the first user repositioning the first window;
wherein the determining a second data set comprising updated state data comprises recalculating the first window position on the first desktop.

27. The method of claim 21, further comprising:
performing a restoration according to a selection of the first user.

28. The method of claim 21, further comprising:
delivering the first data set to a first cloud storage;
in response to a state change, determining a second data set;
delivering the second data set to the first cloud storage;
performing a restoration according to a selection by the first user of the first data set or the second data set.

29. The method of claim 21, further comprising:
wherein the first location is defined or determined using a first reference point and a first desktop identifier, wherein the first reference point is an upper left pixel location of the first application window;
wherein the second location is defined or determined using a second reference point and a second desktop identifier, wherein the second reference point is an upper left pixel location of the second application window.

30. A computer-readable storage medium storing instructions that, when executed, generate on a display device a graphical user interface for presenting work areas and perform the following operations:
determining a first state, wherein determining the first state comprises:
receiving one or more instructions to launch or open at least a first user interface work area, the first user interface work area comprising a first virtual desktop;
receiving one or more instructions to launch or open at least a second user interface work area, the second user interface work area comprising a second virtual desktop;
receiving one or more instructions to open at least a first application window or view in the first user interface work area;
receiving one or more instructions to open at least a second application window or view in the second user interface work area;
creating, modifying, updating, and/or storing a first data set reflecting a first state or configuration;
wherein the first data set comprises:
first position data for the first application window or view in the first user interface work area;
second position data for the second application window or view in the second user interface work area;
determining, detecting, or receiving a restart, roboot, or crash event;
after determining, detecting, or receiving a restart, roboot, or crash event, accessing or reading the first data set reflecting the first state or configuration;
based on the accessing or reading the first data set reflecting the first state or configuration, performing a loading or creation of a first restored state reflecting the first state or configuration.

31. A method performed by one or more processors executing on a computer system, the method comprising:
determining a first state, wherein determining the first state comprises:
receiving one or more instructions allowing a first login action by a first user;
receiving one or more instructions to launch or open at least a first user interface work area comprising a first desktop;
receiving one or more instructions to launch or open at least a second user interface work area comprising a second desktop;
receiving one or more instructions to open at least a first application window in the first user interface work area;
receiving one or more instructions to open at least a second application window in the second user interface work area;
storing a first data set reflecting a first state or configuration in a first memory storage device;
wherein the first data set comprises:
first position data for the first application window on the first desktop;
wherein the first position data comprises:
a first set of values defining a first location and a first size of the first application window in the first user interface work area;
wherein the first set of values comprise a first reference point and a first desktop identifier, wherein the first reference point is an upper left pixel location of the first application window;
second position data for the second application window on the second desktop;
wherein the second position data comprises:
a second set of values defining a second location and a second size of the second application window or view in second user interface work area;
wherein the second set of values comprise a second reference point and a second desktop identifier, wherein the second reference point is an upper left pixel location of the second application window;
determining, detecting, or receiving a restart, roboot, or crash event;
after determining, detecting, or receiving a restart, roboot, or crash event, accessing or reading the first data set reflecting the first state or configuration;
based on the accessing or reading the first data set reflecting the first state or configuration, performing a loading or creation of a first restored state reflecting the first state or configuration.

32. A system comprising:
a display device; and
a computing device in communication with the display device, wherein the computing device is capable of performing at least the following:
receiving one or more instructions to launch or open a first desktop;
receiving one or more instructions to launch or open a second desktop;
receiving one or more instructions to open a first application window on the first desktop;
receiving one or more instructions to open a second application window on the second desktop;
storing a first data set reflecting a first state or configuration in a first memory storage device;
wherein the first data set comprises:
first position data for the first application window on the first desktop;
wherein the first position data comprises:
a first set of values defining a first location and a first size of the first application window on the first desktop;
wherein the first set of values comprise a first reference point and a first desktop identifier, wherein the
first reference point is an upper left pixel location of the first application window;
second position data for the second application window on the second desktop;
wherein the second position data comprises:
a second set of values defining a second location and a second size of the second application window or view on the second desktop;
wherein the second set of values comprise a second reference point and a second desktop identifier, wherein the second reference point is an upper left pixel location of the second application window.

33. The system of claim 32, wherein the computing device is further capable of performing at least the following:
delivering the first data set to a first cloud storage.

34. The system of claim 33, wherein the computing device is further capable of performing at least the following:
receiving one or more instructions allowing a login action by a first user at a client device.

35. The system of claim 34, wherein the computing device is further capable of performing at least the following:
accessing the first data set in the first cloud storage from the client device to restore a session.

36. The system of claim 35, wherein the computing device is further capable of performing at least the following:
in response to a state change, determining a second data set comprising updated state data;
wherein the state change comprises the first user repositioning the first window;
wherein the determining a second data set comprising updated state data comprises recalculating the first window location on the first desktop.

37. The system of claim 32, wherein the computing device is further capable of performing at least the following:
in response to a state change, determining a second data set comprising updated state data;
wherein the state change comprises the first user repositioning the first window;
wherein the determining a second data set comprising updated state data comprises recalculating the first window location on the first desktop.

38. of claim 35, wherein the computing device is further capable of performing at least the following:
performing a restoration according to a selection of the first user.

39. The system of claim 32, wherein the computing device is further capable of performing at least the following:
delivering the first data set to a first cloud storage;
in response to a state change, determining a second data set;
delivering the second data set to the first cloud storage;
performing a restoration according to a selection by the first user of the first data set or the second data set.

40. The system of claim 32, wherein the computing device is further capable of performing at least the following:
displaying a first user view, the first user view comprising:
a first thumbnail view of the first desktop;
a second thumbnail view of the second desktop;
wherein, the first thumbnail view of the first desktop comprises:
a first miniature view of the first application window at a first position on the first desktop;
wherein, the second thumbnail view of the second desktop comprises:
a second miniature view of the second application window at a second position on the second desktop.
